(19) United States
(12) Patent Application Publication
(10) Pub. No.: US 2023/0102499 A1
(43) Pub. Date: Mar. 30, 2023

(54) PRODUCTION OF HIGH-TEST PEROXIDE FOR SPACE MISSIONS, AND ASSOCIATED SYSTEMS AND METHODS

(71) Applicant: Orbit Fab, Inc., Lafayette, CO (US)

(72) Inventors: Connor Benjamin Geiman, Gig Harbor, WA (US); Daniel Ray Faber, Westminster, CO (US); James Bultitude, Boulder, CO (US)

(21) Appl. No.: 17/956,636

(22) Filed: Sep. 29, 2022

Related U.S. Application Data
(60) Provisional application No. 63/251,006, filed on Sep. 30, 2021.

(51) Int. Cl. C25B 1/30; C01B 15/029; C01B 15/013; C25B 1/04; C25B 9/19; C25B 15/08; B64G 1/40; B64G 1/24

(52) U.S. Cl. CPC C25B 1/30; C01B 15/029; C01B 15/013; C25B 1/04; C25B 9/19; C25B 15/083; B64G 1/40; B64G 1/242

(57) ABSTRACT

Systems and methods for production of hydrogen peroxide, such as high-test peroxide, are disclosed. Representative systems and methods also include aerospace systems and space exploration missions implementing systems and methods for production of hydrogen peroxide. A representative system for making hydrogen peroxide can include: a water electrolyzer for receiving water and separating at least some of the water into hydrogen and oxygen; a proton-exchange membrane cell for receiving water, hydrogen from the water electrolyzer, and oxygen from the water electrolyzer and for combining the hydrogen, the oxygen, and the water into a first hydrogen peroxide solution having a first concentration of hydrogen peroxide in water; and a hydrogen peroxide concentrator for removing at least some of the water from the first hydrogen peroxide solution to yield a second hydrogen peroxide solution that has a second concentration of hydrogen peroxide in water that is greater than the first concentration.

### CROSS-REFERENCE TO RELATED APPLICATION(S)

The present application claims priority to U.S. Provisional Patent Application No. 63/251,006, filed Sep. 30, 2021, which is incorporated herein by reference in its entirety.

### TECHNICAL FIELD

The present disclosure is directed generally to systems and methods for production of hydrogen peroxide, such as high-test peroxide. Aspects of the present disclosure can also include aerospace systems and space exploration missions implementing systems and methods for production of high-test peroxide.

### BACKGROUND

Conventional space exploration systems require propellant (such as fuel, oxidizer, and/or monopropellant) to be launched from Earth. Carrying propellant into space from Earth for use in space is costly and inefficient for many space operations. These costs and inefficiencies limit exploration of the Moon, Mars, the asteroids, moons of Jupiter and Saturn, and beyond. Accordingly, there is a desire for in situ resource utilization and in-space manufacturing of propellant. In other words, there is a desire for systems and methods that harvest extraterrestrial resources to create propellant in space rather than bringing it from Earth.

Hydrogen peroxide (H₂O₂), including “high-test” peroxide (“HTP”) (e.g., concentrations of 70%-90%, or greater) is a suitable propellant that can be used in propulsion systems (e.g., thrusters, rocket engines, etc.) as an oxidizer for fuel, or by itself as a monopropellant. HTP is advantageous in space exploration because it is generally safe in storage and it can be produced from sources of oxygen and hydrogen. Many bodies in our Solar System have water (H₂O), so there is great potential for HTP production from extraterrestrial bodies. However, existing HTP production (e.g., an anthraquinone oxidation process) requires large facilities, uses substantial energy, and/or involves hazardous solvents and/or wastes.

Embodiments of the present technology are directed to addressing these and other challenges and desires associated with manufacture of propellant (e.g., H₂O₂, such as HTP) in extraterrestrial or terrestrial environments.

### BRIEF DESCRIPTION OF THE DRAWINGS

In the drawings, wherein the same reference number indicates the same element throughout the views:

FIG. 1 illustrates a schematic diagram of a system for making hydrogen peroxide, configured in accordance with embodiments of the present technology;

FIG. 2 illustrates alternative configurations of a proton-exchange membrane (PEM) cell suitable for use in a system for making hydrogen peroxide (such as the system shown in FIG. 1), in accordance with embodiments of the present technology;

FIG. 3 illustrates a schematic diagram of an aerospace system configured in accordance with embodiments of the present technology, in which the system shown and described with regard to FIGS. 1 and 2 can be implemented;

FIG. 4 illustrates a method of carrying out a space mission utilizing systems configured in accordance with embodiments of the present technology; and

FIG. 5 illustrates a schematic view of space missions implementing embodiments of the present technology.

### DETAILED DESCRIPTION

Embodiments of the technology disclosed herein are directed generally to systems and methods for production of hydrogen peroxide, such as high-test peroxide. Several embodiments of the present technology are directed to use in extraterrestrial environments such as in orbit, or on a surface of the Moon or asteroids or other planets, but the present technology can also be implemented in terrestrial environments (i.e., on Earth). Embodiments of the present technology can be implemented in space missions that visit moons, asteroids, and/or other planets.

A representative system for making hydrogen peroxide can include: a water electrolyzer for receiving water and separating at least some of the water into hydrogen and oxygen; a proton-exchange membrane (PEM) cell for receiving water, at least some of the hydrogen from the water electrolyzer, and at least some of the oxygen from the water electrolyzer, and for combining at least some of the hydrogen, at least some of the oxygen, and at least some of the water into a first hydrogen peroxide solution having a first concentration of hydrogen peroxide in water; and a hydrogen peroxide concentrator configured to remove at least some of the water from the first hydrogen peroxide solution to yield a second hydrogen peroxide solution that has a second concentration of hydrogen peroxide in water that is greater than the first concentration. Further embodiments can include storage vessels for the water, the hydrogen, the oxygen, the first hydrogen peroxide solution, and/or the second hydrogen peroxide solution. In some embodiments, the water can come from a water harvesting system for extracting water from icy regolith and/or other materials. Advantageously, some embodiments of the system can include no additives (or eliminate a need for additives) to the water provided to the PEM cell, to the hydrogen provided to the PEM cell, or to the oxygen provided to the PEM cell.

Another representative system for making hydrogen peroxide can include: a PEM cell for receiving water and air, wherein the air includes oxygen and the PEM cell combines hydrogen from the water and oxygen from the air to form a first hydrogen peroxide solution having a first concentration of hydrogen peroxide in water; and a hydrogen peroxide concentrator configured to remove at least some of the water from the first hydrogen peroxide solution to yield a second hydrogen peroxide solution that has a second concentration of hydrogen peroxide in water that is greater than the first concentration. The system can optionally include a water electrolyzer for providing the air.

A representative method of making hydrogen peroxide can include: receiving water in a water electrolyzer; converting the water to gaseous hydrogen and gaseous oxygen; receiving at least some of the gaseous hydrogen and at least some of the gaseous oxygen in a PEM cell that is operatively connected to the water electrolyzer; receiving water in the PEM cell; forming a first hydrogen peroxide solution having a first concentration of hydrogen peroxide in water, using the water, the at least some of the gaseous hydrogen, and the at least some of the gaseous oxygen; receiving the first hydrogen peroxide solution in a hydrogen peroxide concentrator operatively connected to the PEM cell; and removing at least some of the water from the first hydrogen peroxide solution to yield a second hydrogen peroxide solution that has a second concentration of hydrogen peroxide in water that is greater than the first concentration.

A representative aerospace system configured in accordance with embodiments of the present technology can include one or more controllers programmed with instructions that, when executed: operate a PEM cell to receive water and air, wherein the air includes oxygen and the PEM cell combines hydrogen from the water and oxygen from the air to form a first hydrogen peroxide solution having a first concentration of hydrogen peroxide in water; operate a hydrogen peroxide concentrator to remove at least some of the water from the first hydrogen peroxide solution to yield a second hydrogen peroxide solution that has a second concentration of hydrogen peroxide in water that is greater than the first concentration; and operate a propulsion system of a space vehicle using the second hydrogen peroxide solution as propellant. In further representative embodiments, the one or more controllers are programmed with instructions that, when executed, launch the space vehicle toward a first destination and land the space vehicle at the first destination. In some embodiments, the PEM cell and the hydrogen peroxide concentrator are operated at the first destination. The system can launch the space vehicle from the first destination using the second hydrogen peroxide solution as propellant. In some embodiments, the instructions further include operating a water electrolyzer to produce the air from water. A further representative embodiment includes the space vehicle, the PEM cell, the hydrogen peroxide concentrator, and, optionally, the water electrolyzer. The space vehicle can carry the PEM cell, the hydrogen peroxide concentrator, and/or the water electrolyzer.

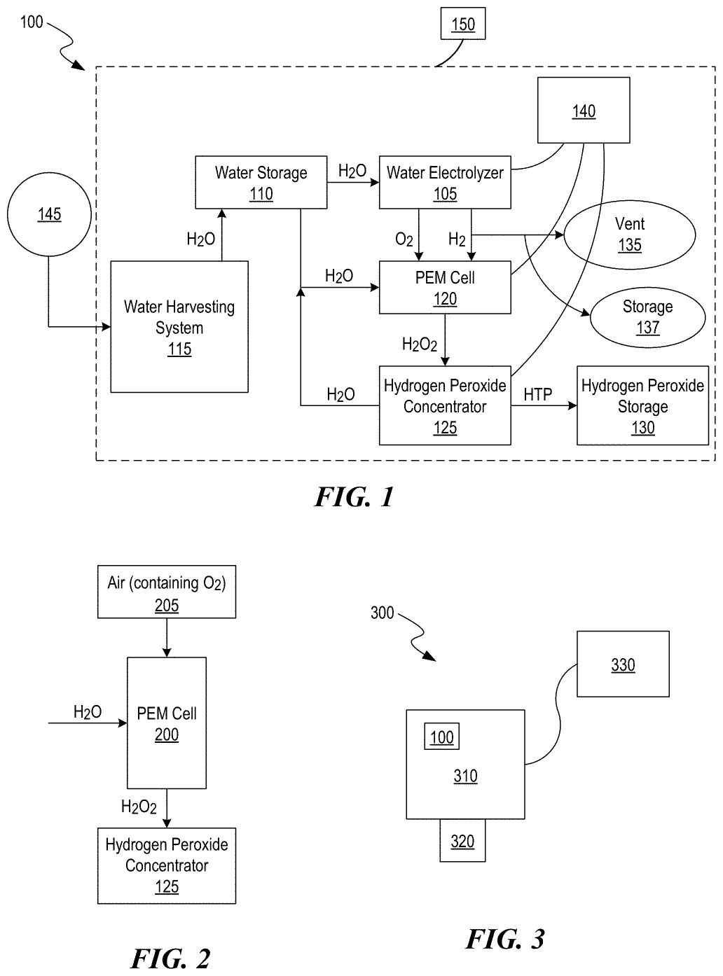

Several details describing structures and processes that are well-known and often associated with liquid and/or gas storage and/or transportation, and/or chemical systems and processes, are not set forth in the following description to avoid obscuring other aspects of the disclosure. Moreover, although the following disclosure sets forth several embodiments, several other embodiments can have configurations, arrangements, and/or components that are different than those described in this section. In particular, other embodiments may have additional elements, and/or may lack one or more of the elements described below with reference to FIGS. 1-5.

FIG. 1 illustrates a schematic diagram of a system 100 for making hydrogen peroxide (and optionally for storing it), configured in accordance with embodiments of the present technology. In FIG. 1, several compounds and/or chemicals (e.g., H₂O, O₂, H₂, H₂O₂, and HTP) are labeled to show some of their locations in the system 100. In some embodiments, the system can include a water electrolyzer 105 for receiving water and separating (dissociating) at least some of the water into hydrogen and oxygen. The water electrolyzer 105 can receive the water from a water storage system or vessel 110 and/or from another water source, such as a water harvesting system 115, which is described in further detail below. The system 100 can include any suitable water electrolyzer, however, in some embodiments it is preferred that the water electrolyzer be capable of functioning in a reduced gravity and/or microgravity environment. For example, in some embodiments, the water electrolyzer 105 can include aspects of a water-to-hydrogen and oxygen thruster built by Tethers Unlimited, Inc., of Bothell Wash.

The system 100 can further include a proton-exchange membrane (PEM) cell 120 operatively connected to the water electrolyzer 105, via suitable plumbing, reservoirs, and/or other systems for transmitting hydrogen and/or oxygen from the water electrolyzer 105 to the PEM cell 120. The PEM cell 120 can also receive water (e.g., via an operative connection with the vessel 110 and/or from another water source). The PEM cell 120 receives the water, at least some of the hydrogen from the water electrolyzer 105, and at least some of the oxygen from the water electrolyzer 105. According to established chemical science known to those of ordinary skill in the art, the PEM cell 120 combines at least some of the hydrogen, at least some of the oxygen, and at least some of the water into a first hydrogen peroxide solution (H₂O₂) having a first concentration of hydrogen peroxide in water. The PEM cell 120 outputs the first hydrogen peroxide solution. In some embodiments, the first concentration can be less than 50% (for example, approximately 10%), or other values.

In some embodiments, the suitable PEM cell 120 can include a porous solid electrolyte positioned between an anode and a cathode, through which water is passed, while adding hydrogen and oxygen gas. Such a suitable PEM cell 120 can include technology developed by Rice University and described in “Direct Electrosynthesis of Pure Aqueous H₂O₂ Solutions up to 20% by Weight Using a Solid Electrolyte” by Chuan Xia, et al., Science, vol. 366, no. 6462, October 2019, pp. 226-31, and/or in U.S. Patent Application Publication No. 2022/0259746, for example, which are incorporated herein by reference. Other embodiments can include other suitable PEM cells. Although some embodiments can include a PEM cell that uses a liquid electrolyte, the solid electrolyte PEM cell is preferred at least because it reduces complexity and reduces (e.g., eliminates) a need for additives (e.g., a liquid electrolyte, such as KOH or H₂SO₄). Such reduced complexity and reduced need for additives is advantageous in a space environment where weight should be minimized.

The system 100 can further include a hydrogen peroxide concentrator 125 operatively connected to the PEM cell 120 in a manner suitable for providing hydrogen peroxide from the PEM cell 120 to the hydrogen peroxide concentrator 125 (e.g., via suitable plumbing, reservoirs, and/or other suitable systems). The hydrogen peroxide concentrator 125 receives the first hydrogen peroxide solution from the PEM cell 120 and removes at least some of the water from the first hydrogen peroxide solution to yield a second hydrogen peroxide solution that has a second concentration of hydrogen peroxide in water that is greater than the first concentration. For example, output of the hydrogen peroxide concentrator 125 can include high-test peroxide (HTP). In some embodiments, the hydrogen peroxide concentrator 125 can be operatively connected to a hydrogen peroxide storage system or vessel 130 for storing the second hydrogen peroxide solution (e.g., HTP), and/or the hydrogen peroxide concentrator 125 can be operatively connected to another suitable storage and/or usage device. In a particular representative embodiment, the vessel 130 for storing the second hydrogen peroxide solution (e.g., HTP) can be, and/or can include, a propellant tank in a spacecraft.

In some embodiments, the hydrogen peroxide concentrator 125 can include a vacuum distiller for receiving and distilling the first hydrogen peroxide solution, a deionizer for deionizing the output of the vacuum distiller, and/or an air stripper for removing air from the output of the deionizer. The output of the air stripper (and/or the overall hydrogen peroxide concentrator 125) can include the second hydrogen peroxide solution (e.g., HTP). In some embodiments, the vacuum distiller and/or the air stripper also output water that has been stripped from the first hydrogen peroxide solution, such that output of the hydrogen peroxide concentrator 125 can also include excess water (H₂O).

In general, because the hydrogen peroxide concentrator 125 removes water from the first hydrogen peroxide solution, output of the hydrogen peroxide concentrator 125 can include water. Accordingly, the hydrogen peroxide concentrator 125 can be operatively connected to the PEM cell 120 in a suitable manner for transmitting the water to the PEM cell 120 for use in creating the first hydrogen peroxide solution. In some embodiments, the hydrogen peroxide concentrator 125 can be operatively connected to the vessel 110 for storing the water removed from the first hydrogen peroxide solution, and/or the hydrogen peroxide concentrator 125 can be operatively connected to something else for other uses of the water. A suitable hydrogen peroxide concentrator 125 can include such a system by X-L Space Systems, and/or can include a system described in U.S. Pat. No. 6,290,820 by Michael Carden, for example, the disclosure of which is incorporated herein by reference.

In some embodiments, the system 100 can include a vent 135 for releasing (e.g., discarding) excess hydrogen from the water electrolyzer 105. In some embodiments, the system 100 can include a storage device 137 for receiving and storing the excess hydrogen from the water electrolyzer 105. In some embodiments, the system 100 can include a controller 140 operatively connected to the water electrolyzer 105, the PEM cell 120, and/or the hydrogen peroxide concentrator 125 for managing the flow of liquids and/or gases and for controlling the system 100 to produce the second hydrogen peroxide solution according to the process described above.

The science and chemistry behind water electrolyzers, PEM cells, and hydrogen peroxide concentrators are known in the chemical arts, however, these systems and components have not been combined in the manner according to the present technology to yield HTP. The inventors discovered this combination of devices to be efficient for producing HTP without the need for chemical additives or additional processes or resources. Accordingly, in some embodiments, the system 100 does not include or involve intentional ingredients or additives other than water. In some embodiments, a stabilizer can be added to the second hydrogen peroxide solution or elsewhere in the process or system for safety, however, in general, the system 100 does not use or require additives that are conventionally associated with the anthraquinone oxidation process. Accordingly, fewer ingredients are needed in the process according to the present technology, which minimizes weight for space applications.

In some embodiments, the water electrolyzer 105 receives liquid water and outputs the hydrogen and oxygen as gas, although other embodiments can output the hydrogen and/or oxygen in a liquid or partially liquid form. In some embodiments, the PEM cell 120 receives the hydrogen and oxygen in gaseous form, although other embodiments can include the PEM cell 120 receiving liquid hydrogen and/or liquid oxygen and/or partially liquid forms of each. In some representative embodiments, the first concentration of hydrogen peroxide in water (output from the PEM cell 120) can be up to 20% (by weight), and the output can be in liquid form. In some representative embodiments, the second concentration of hydrogen peroxide in water (output from the hydrogen peroxide concentrator 125) can be at least 70% (by weight), at least 90% (by weight), up to 98% (by weight), or other quantities. In some embodiments, the electrolysis reaction/process in the water electrolyzer 105 is stoichiometric. In some embodiments, the moles of oxygen input to the PEM cell 120 is greater than the moles of hydrogen peroxide output from the PEM cell 120.

In some embodiments, the water harvesting system 115 collects and/or receives ice (e.g., regolith ice) from an extraterrestrial body 145 (e.g., an asteroid, a moon, and/or another planet, etc.) and processes it into water (e.g., extracts water from the regolith). The water can be stored in the vessel 110 and/or provided directly to the water electrolyzer 105 and/or the PEM cell 120. Water harvesting systems suitable for use as the water harvesting system 115 in the system 100 are known in the space exploration industry. For example, a suitable water harvesting system can include aspects of systems made by TransAstra Corporation. Accordingly, systems configured in accordance with embodiments of the present technology (e.g., the system 100 shown in FIG. 1) can produce HTP from icy regolith in extraterrestrial environments, which reduces (e.g., minimizes) the need for bringing propellants from Earth for space missions.

The components described above and schematically illustrated in FIG. 1 can be interconnected (e.g., couplable together) using any suitable operative connections, such as plumbing, valves, and/or other suitable ways to transmit and/or transport liquids and gases among the components. The system 100 can include one or more power supplies 150 (illustrated schematically) for supplying power to one or more (such as all) of the components of the system 100. In some embodiments, the power supply or power supplies 150 can include one or more solar panels, batteries, and/or other sources of power (such as electrical power from a source on Earth, if the system is implemented on Earth). In some embodiments, the system 100 (such as the water electrolyzer 105, the PEM cell 120, the hydrogen peroxide concentrator 125, and/or other components) can use approximately 10 kilowatts to 30 kilowatts of energy, or other amounts of energy, depending on the sizes of the components and other factors. In some embodiments, for context, a configuration of the water electrolyzer 105, the PEM cell 120, and the hydrogen peroxide concentrator 125 that produces approximately 10 kilograms of HTP per day can weigh approximately 100 kilograms. Other embodiments can include other weights, production levels, or amounts of energy consumption.

FIG. 2 illustrates an alternative configuration of a PEM cell 200 suitable for use in a system (such as the system 100 described above) for making hydrogen peroxide, in accordance with embodiments of the present technology. The PEM cell 200 can be used in addition to, or in place of, the PEM cell 120 described above with respect to FIG. 1.

For example, in some embodiments, the system 100 can omit a water electrolyzer 105, and the PEM cell 200 can receive air from another air source (such as an air source 205, which can include an air storage system). The air source 205 can include at least oxygen and/or at least hydrogen. In some embodiments, the PEM cell 200 can receive an input of water (H₂O). For example, the PEM cell 200 can receive water in the same manner as the manner in which the PEM cell 120 receives water, as described above with regard to FIG. 1. According to established chemical science, the PEM cell 200 combines hydrogen from the water and the oxygen from the air to form a first hydrogen peroxide solution having a first concentration of hydrogen peroxide in water, which is provided to the hydrogen peroxide concentrator 125 (see FIG. 1). In further embodiments, the PEM cell 200 can receive hydrogen instead of water, along with air from the air source 205 that contains at least oxygen, to produce the first hydrogen peroxide solution. In general, the PEM cell 200 can include embodiments that receive oxygen and hydrogen from any suitable source.

Optionally, the water electrolyzer 105 (see FIG. 1) can be operatively connected to the PEM cell 200 for providing the air (with oxygen and/or hydrogen) to the PEM cell 200. For example, in FIG. 2, the air source 205 can include and/or be operatively connected to the water electrolyzer 105. Accordingly, the PEM cell 200 can be a substitute for, and/or an alternative to, the PEM cell 120.

In view of the foregoing, embodiments of the present technology can include several architectures, such as (a) using sources of hydrogen, oxygen, and water to create HTP; (b) using a source of oxygen and water to create HTP; (c) using a source of air (containing at least oxygen and/or hydrogen) and water to create HTP; and (d) using a source of water alone to create HTP.

FIG. 3 illustrates a schematic diagram of an aerospace system 300 configured in accordance with embodiments of the present technology, in which the system 100 can be implemented. In some embodiments, the aerospace system 300 can include a space vehicle 310. The space vehicle 310 can include at least some conventional aspects of a space vehicle, such as one or more stages of a launch vehicle, one or more power systems, guidance systems, navigation systems, one or more propulsion systems 320 (e.g., one or more rocket engines and/or thrusters), and/or cargo intended for space travel such as a satellite or a probe. For simplicity in illustration and description, references to the “space vehicle 310” herein can include reference to an entirety of the space vehicle 310, at least one or more stages or portions of the space vehicle 310, and/or one or more self-propelled satellites or self-propelled probes for space exploration. The propulsion systems 320 may be configured to use hydrogen peroxide propellant as an oxidizer and/or as a monopropellant. In some embodiments, the aerospace system 300 can include one or more controllers 330 programmed with instructions that, when executed, operate the system 100 for making hydrogen peroxide and/or components of the space vehicle 310 to carry out a space mission, such as one or more of the space missions described below. In some embodiments, the space vehicle 310 can carry the system 100 and/or the space vehicle 310 can be operatively connected to the system 100 (e.g., for receiving HTP in the space vehicle 310).

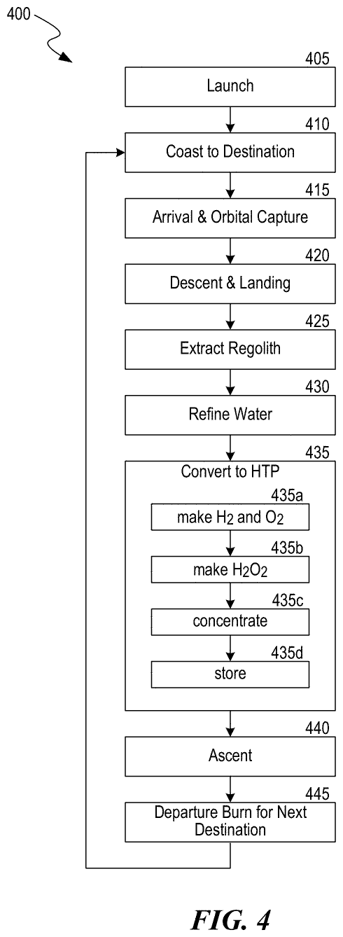

FIG. 4 illustrates a method 400 of carrying out a space mission utilizing systems configured in accordance with embodiments of the present technology (such as the systems 100, 300 described above with regard to FIGS. 1-3), in accordance with embodiments of the present technology. The one or more controllers 330 (see FIG. 3) can be programmed with instructions that, when executed, carry out some or all portions of the method 400.

At block 405, the space vehicle 310 launches from Earth or an extraterrestrial location. At block 410, after the space vehicle 310 reaches space, at least a portion of the space vehicle 310 (e.g., an upper stage portion, a satellite, or a probe) travels toward a first destination (e.g., by coasting and/or by propulsion), such as an asteroid, the Moon, another planet, or a moon of another planet. At block 415, the space vehicle 310 can arrive at the first destination and become captured in its orbit. At block 420, the space vehicle 310 can descend and land on the first destination (e.g., using one or more of the propulsion systems 320). At block 425, the system 100 for making hydrogen peroxide (which can be carried by the space vehicle 310) can extract water and/or regolith containing water from the first destination. At block 430, the water harvesting system 115 can refine the water and/or regolith into water that the system 100 can use to create the hydrogen peroxide.

At block 435, the system 100 can convert the water to hydrogen peroxide (e.g., HTP), as described above with regard to FIGS. 1 and 2. For example, at block 435a, the water electrolyzer 105 can make hydrogen and oxygen. Next, at block 435b, the PEM cell 120 can make the hydrogen peroxide solution having the first concentration. Next, at block 435c, the hydrogen peroxide concentrator 125 can make the hydrogen peroxide solution having the second concentration (e.g., HTP). Next, at block 435d, the system 100 can store the hydrogen peroxide having the second concentration (e.g., onboard the space vehicle 310). In some embodiments, storage at block 435d can include adding minimal suitable amounts of a stabilizer material for safety (e.g., stannate materials, such as sodium stannate, or other suitable stabilizer materials). Throughout the process in block 435 and other processes described herein in association with the system 100, embodiments of the present technology can include monitoring output of the PEM cell 120 and the hydrogen peroxide concentrator 125 to observe their flow rates and the potential presence of impurities. Such observation facilitates evaluation of the overall health of the system 100.

Having HTP monopropellant and/or HTP as an oxidizer for fuel, at block 440 the aerospace system 300 can operate the one or more propulsion systems 320 to launch and ascend the space vehicle 310 from the first destination. HTP has sufficient specific impulse for ascent from relatively small bodies such as the Moon or an asteroid, or from even larger bodies.

Then, at block 445, the aerospace system 300 can operate the one or more propulsion systems 320 to depart the first destination and travel toward a second destination (e.g., another asteroid, planet, or moon). The method 400 can return to block 410 to repeat blocks 410-445 indefinitely for the second, third, fourth, and more destinations, as long as the aerospace system 300 can continue to operate or as long as the desired timeline for the overall mission. Production of hydrogen peroxide from in-situ water enables the aerospace system 300 to operate for extended periods of time and explore several bodies in space, with multiple rendezvous and landings. In some embodiments, the aerospace system 300 can carry out scientific investigations while on orbit at a destination and/or while on a surface of a destination.

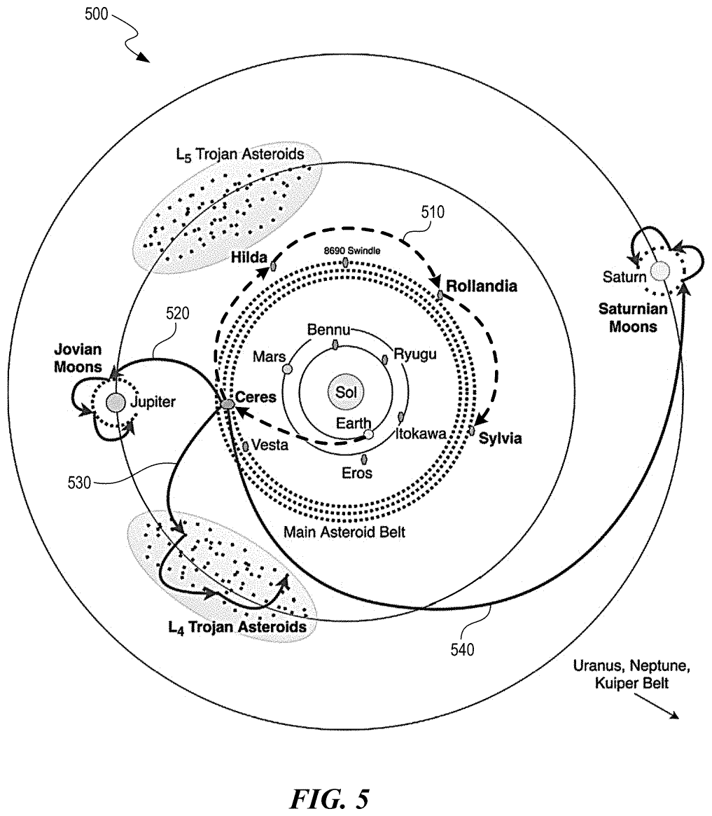

FIG. 5 illustrates a schematic view 500 of several space missions implementing embodiments of the present technology. A first tour 510 can include the space vehicle 310 visiting several small bodies. First and second alternative tours 510, 520 can include the space vehicle 310 visiting various moons. A third alternative tour 530 can include the space vehicle 310 visiting asteroids.

Representative embodiments of the present technology include can include components and overall systems that are less expensive, smaller, and less complex than existing HTP production systems and methods. For example, a representative system can weigh a total of approximately one-hundred kilograms and can produce multiple liters per hour of HTP, using less than 25 kilowatts of energy, or other suitable sizes and amounts of energy consumption that are suitable for implementations on space vehicles using space-enabled power sources (e.g., batteries, solar power, etc). Representative embodiments of the present technology can produce hydrogen peroxide without many of (or any of) the chemical additives or other complicated processes that are associated with conventional production such as the anthraquinone process, and/or which are unavailable and/or inefficient in an extraterrestrial environment. Embodiments of the present technology enable in-situ production of propellant (HTP) on the Moon, an asteroid, or another extraterrestrial (or terrestrial) body using only water (which can be found on those extraterrestrial bodies).

From the foregoing, it will be appreciated that specific embodiments of the disclosed technology have been described herein for purposes of illustration, but that various modifications may be made without deviating from the technology. For example, although “water” and “H₂O” are illustrated and described, such references to “water” and “H₂O” can include impure water (e.g., water with impurities). Although some embodiments can minimize and/or eliminate a need for KOH and/or H₂SO₄, some embodiments can still include KOH and/or H₂SO₄. Some embodiments can implement systems for removing impurities from water and/or air. In addition, hydrogen peroxide (e.g., HTP) created by systems according to the present technology need not be used for rocket propulsion and/or in space. Rather, the technology described herein may be implemented in an Earth-based system and/or it may be used for applications other than rocket propulsion, such as energy generation or other applications. The advantages of an Earth-based system can be similar to the advantages of a space-based system, such as reduced size, weight, complexity, and/or ingredients for the process as compared to conventional processes such as the anthraquinone process.

Although specific quantities, dimensions, or other numerical characterizations are provided for context and/or to indicate representative embodiments, various further embodiments can have other quantities, sizes, or characteristics. Certain aspects of the technology described in the context of particular embodiments may be combined or eliminated in other embodiments. Further, while advantages associated with certain embodiments of the disclosed technology have been described in the context of those embodiments, other embodiments may also exhibit such advantages, and not all embodiments need necessarily exhibit such advantages to fall within the scope of the present technology. Accordingly, the present disclosure and associated technology can encompass other embodiments not expressly shown or described herein.

Singular or plural terms can also include the plural or singular term, respectively. As used herein, the term “and/or” when used in the phrase “A and/or B” means “A, or B, or both A and B.” A similar manner of interpretation applies to the term “and/or” when used in a list of more than two terms. As used herein, the terms “generally” and “approximately” refer to values or characteristics within a range of ±10% from the stated value or characteristic, unless otherwise indicated. To the extent any materials incorporated herein by reference conflict with the present disclosure, the present disclosure controls.

Many embodiments of the technology described herein can take the form of computer- or controller-executable instructions, including routines executed by a programmable computer or controller. Those skilled in the relevant art will appreciate that the technology can be practiced on computer/controller systems other than those shown and described herein. The technology can be embodied in a special-purpose computer, controller, or other data processor or circuitry that is specifically programmed, configured, or constructed to perform one or more of the computer-executable (controller-executable) instructions (e.g., methods) described herein. Accordingly, the terms “computer” and “controller” as generally used herein refer to any data processor and can include Internet appliances and hand-held devices (including palm-top computers, wearable computers, cellular or mobile phones, multiprocessor systems, processor-based or programmable consumer electronics, network computers, mini computers, and the like), programmable general-purpose or special-purpose microprocessors, programmable controllers (such as programmable logic controllers), programmable logic devices (PLDs), application-specific integrated circuits (ASICs), field-programmable gate arrays (FPGAs) or the like, microcontrollers (such as embedded microcontrollers), and/or any suitable combination of such devices. Computer-executable (controller-executable) instructions and/or databases may be stored in memory, such as random-access memory (RAM), read-only memory (ROM), flash memory, or the like, and/or any suitable combination of such components. Computer-executable (controller-executable) instructions and/or databases may also be stored in one or more storage devices, such as magnetic or optical-based disks, flash memory devices, and/or any other suitable type of volatile or non-volatile storage medium or non-transitory medium for data. Computer-executable (controller-executable) instructions may include one or more program modules, which can include routines, programs, objects, components, data structures, and so on that perform particular tasks and/or implement particular abstract data types. Information handled by these computers and controllers can be presented at any suitable display medium, including an LCD or via indicator lights or audible annunciators (for example, a display, light, or other annunciator).

The technology can also be practiced in distributed environments, where tasks or modules are performed by remote processing devices that are linked through a communications network (e.g., a wireless communication network, a wired communication network, a cellular communication network, the Internet, and/or a short-range radio network such as Bluetooth) and/or via analog signals. In a distributed computing environment, program modules and/or subroutines may be located in local and remote memory storage devices. Aspects of the technology described herein may be stored and/or distributed on computer-readable media, including magnetic or optically readable or removable computer disks, as well as distributed electronically over networks. Data structures and transmissions of data particular to aspects of the technology are also encompassed within the scope of the embodiments of the technology.

The following Examples include additional embodiments of the present technology:

1. A system for making hydrogen peroxide, the system comprising:
a water electrolyzer coupleable to a water source and one or more power supplies, wherein the water electrolyzer is positioned to dissociate at least some of the water into hydrogen and oxygen;
a proton-exchange membrane (PEM) cell couplable to the water electrolyzer, the water source, and the one or more power power supplies, wherein the PEM cell is positioned to receive water, at least some of the hydrogen from the water electrolyzer, and at least some of the oxygen from the water electrolyzer and to combine at least some of the hydrogen, at least some of the oxygen, and at least some of the water into a first hydrogen peroxide solution having a first concentration of hydrogen peroxide in water; and
a hydrogen peroxide concentrator coupleable to the PEM cell and the one or more power supplies, wherein the hydrogen peroxide concentrator is positioned to remove at least some of the water from the first hydrogen peroxide solution to yield a second hydrogen peroxide solution that has a second concentration of hydrogen peroxide in water that is greater than the first concentration.

2. The system of example 1, wherein the water source comprises a water storage vessel.

3. The system of example 1 or example 2, further comprising a water harvesting system couplable to the water storage vessel and/or the water electrolyzer, wherein the water harvesting system is positioned to extract water from icy regolith.

4. The system of any of examples 1-3, wherein the system eliminates a need for potassium hydroxide (KOH) or sulfuric acid (H₂SO₄).

5. The system of any of examples 1-4, further comprising a vent coupleable to the water electrolyzer and positioned to release excess gas.

6. The system of any of examples 1-5, further comprising a storage container couplable to the water electrolyzer and positioned to store excess gas.

7. The system of any of examples 1-6, wherein the second concentration of hydrogen peroxide in the water is at least 70%.

8. The system of any of examples 1-6, wherein the second concentration of hydrogen peroxide in the water is at least 90%.

9. A system for making hydrogen peroxide, the system comprising:
a proton-exchange membrane (PEM) cell coupleable to a water source and one or more power supplies, wherein the PEM cell is positioned to receive water and air, wherein the air comprises oxygen and the PEM cell combines hydrogen from the water and oxygen from the air to form a first hydrogen peroxide solution having a first concentration of hydrogen peroxide in water; and
a hydrogen peroxide concentrator coupleable to the PEM cell and the one or more power supplies, wherein the hydrogen peroxide concentrator is positioned to remove at least some of the water from the first hydrogen peroxide solution to yield and output a second hydrogen peroxide solution that has a second concentration of hydrogen peroxide in water that is greater than the first concentration.

10. The system of example 9, further comprising a water electrolyzer operably coupleable to the water source, wherein the water electrolyzer is positioned to receive water and dissociate at least some of the water into hydrogen and oxygen, and wherein the air comprises the hydrogen and the oxygen.

11. The system of example 9 or example 10, further comprising a water harvesting system coupleable to the PEM cell and/or to a water storage vessel, wherein the water harvesting system is positioned to receive icy regolith and convert the icy regolith to water.

12. The system of any of examples 9-11, wherein the second concentration of hydrogen peroxide in the water is at least 70%.

13. The system of any of examples 9-12, wherein the second concentration of hydrogen peroxide in the water is at least 90%.

14. A method of making hydrogen peroxide, the method comprising:
receiving water in a water electrolyzer;
converting the water to gaseous hydrogen and gaseous oxygen;
receiving at least some of the gaseous hydrogen and at least some of the gaseous oxygen in a proton-exchange membrane (PEM) cell that is operatively connected to the water electrolyzer;
receiving water in the PEM cell;
forming a first hydrogen peroxide solution having a first concentration of hydrogen peroxide in water, wherein forming the first hydrogen peroxide solution comprises using the water, the at least some of the gaseous hydrogen, and the at least some of the gaseous oxygen;
receiving the first hydrogen peroxide solution in a hydrogen peroxide concentrator operatively connected to the PEM cell; and
removing at least some of the water from the first hydrogen peroxide solution to yield a second hydrogen peroxide solution that has a second concentration of hydrogen peroxide in water that is greater than the first concentration.

15. The method of example 14, further comprising harvesting the water from icy regolith, and providing the water to the water electrolyzer.

16. The method of example 14 or example 15, wherein the method does not require potassium hydroxide (KOH) or sulfuric acid (H₂SO₄).

17. The method of any of examples 14-16, wherein the second concentration of hydrogen peroxide in the water is at least 70%.

18. The method of any of examples 14-16, wherein the second concentration of hydrogen peroxide in the water is at least 90%.

19. An aerospace system comprising one or more controllers programmed with instructions that, when executed:
operate a proton-exchange membrane (PEM) cell to receive water and air, wherein the air comprises oxygen and the PEM cell combines hydrogen from the water and oxygen from the air to form a first hydrogen peroxide solution having a first concentration of hydrogen peroxide in water;
operate a hydrogen peroxide concentrator to remove at least some of the water from the first hydrogen peroxide solution to yield a second hydrogen peroxide solution that has a second concentration of hydrogen peroxide in water that is greater than the first concentration; and
operate a propulsion system of a space vehicle using the second hydrogen peroxide solution as propellant.

20. The aerospace system of example 19, wherein the one or more controllers are further programmed with instructions that, when executed:
launch the space vehicle toward a first destination; and
land the space vehicle at the first destination; wherein:
operating the PEM cell comprises operating the PEM cell at the first destination; and
operating the hydrogen peroxide concentrator comprises operating the hydrogen peroxide concentrator at the first destination.

21. The aerospace system of example 19 or example 20, wherein the one or more controllers are further programmed with instructions that, when executed, operate a water harvesting system to produce or harvest water from the first destination.

22. The aerospace system of example 20 or example 21, wherein the one or more controllers are further programmed with instructions that, when executed, launch the space vehicle from the first destination, wherein launching the space vehicle from the first destination comprises operating the propulsion system of the space vehicle using the second hydrogen peroxide solution as propellant.

23. The aerospace system of any of examples 19-22, wherein the one or more controllers are further programmed with instructions that, when executed, operate a water electrolyzer to produce the air from water.

24. The aerospace system of example 23, further comprising the space vehicle, the PEM cell, the hydrogen peroxide concentrator, and the water electrolyzer, and wherein the space vehicle carries the PEM cell, the hydrogen peroxide concentrator, and the water electrolyzer.

I/We claim:

1. A system for making hydrogen peroxide, the system comprising:
a water electrolyzer coupleable to a water source and one or more power supplies, wherein the water electrolyzer is positioned to dissociate at least some of the water into hydrogen and oxygen;
a proton-exchange membrane (PEM) cell couplable to the water electrolyzer, the water source, and the one or more power power supplies, wherein the PEM cell is positioned to receive water, at least some of the hydrogen from the water electrolyzer, and at least some of the oxygen from the water electrolyzer and to combine at least some of the hydrogen, at least some of the oxygen, and at least some of the water into a first hydrogen peroxide solution having a first concentration of hydrogen peroxide in water; and
a hydrogen peroxide concentrator coupleable to the PEM cell and the one or more power supplies, wherein the hydrogen peroxide concentrator is positioned to remove at least some of the water from the first hydrogen peroxide solution to yield a second hydrogen peroxide solution that has a second concentration of hydrogen peroxide in water that is greater than the first concentration.

2. The system of claim 1, wherein the water source comprises a water storage vessel.

3. The system of claim 2, further comprising a water harvesting system couplable to the water storage vessel and/or the water electrolyzer, wherein the water harvesting system is positioned to extract water from icy regolith.

4. The system of claim 1, wherein the system eliminates a need for potassium hydroxide (KOH) or sulfuric acid (H₂SO₄).

5. The system of claim 1, further comprising a vent coupleable to the water electrolyzer and positioned to release excess gas.

6. The system of claim 1, further comprising a storage container couplable to the water electrolyzer and positioned to store excess gas.

7. The system of claim 1, wherein the second concentration of hydrogen peroxide in the water is at least 70%.

8. The system of claim 7, wherein the second concentration of hydrogen peroxide in the water is at least 90%.

9. A system for making hydrogen peroxide, the system comprising:
a proton-exchange membrane (PEM) cell coupleable to a water source and one or more power supplies, wherein the PEM cell is positioned to receive water and air, wherein the air comprises oxygen and the PEM cell combines hydrogen from the water and oxygen from the air to form a first hydrogen peroxide solution having a first concentration of hydrogen peroxide in water; and
a hydrogen peroxide concentrator coupleable to the PEM cell and the one or more power supplies, wherein the hydrogen peroxide concentrator is positioned to remove at least some of the water from the first hydrogen peroxide solution to yield and output a second hydrogen peroxide solution that has a second concentration of hydrogen peroxide in water that is greater than the first concentration.

10. The system of claim 9, further comprising a water electrolyzer operably coupleable to the water source, wherein the water electrolyzer is positioned to receive water and dissociate at least some of the water into hydrogen and oxygen, and wherein the air comprises the hydrogen and the oxygen.

11. The system of claim 9, further comprising a water harvesting system coupleable to the PEM cell and/or to a water storage vessel, wherein the water harvesting system is positioned to receive icy regolith and convert the icy regolith to water.

12. The system of claim 9, wherein the second concentration of hydrogen peroxide in the water is at least 70%.

13. The system of claim 12, wherein the second concentration of hydrogen peroxide in the water is at least 90%.

14. A method of making hydrogen peroxide, the method comprising:
receiving water in a water electrolyzer;
converting the water to gaseous hydrogen and gaseous oxygen;
receiving at least some of the gaseous hydrogen and at least some of the gaseous oxygen in a proton-exchange membrane (PEM) cell that is operatively connected to the water electrolyzer;
receiving water in the PEM cell;
forming a first hydrogen peroxide solution having a first concentration of hydrogen peroxide in water, wherein forming the first hydrogen peroxide solution comprises using the water, the at least some of the gaseous hydrogen, and the at least some of the gaseous oxygen;
receiving the first hydrogen peroxide solution in a hydrogen peroxide concentrator operatively connected to the PEM cell; and
removing at least some of the water from the first hydrogen peroxide solution to yield a second hydrogen peroxide solution that has a second concentration of hydrogen peroxide in water that is greater than the first concentration.

15. The method of claim 14, further comprising harvesting the water from icy regolith, and providing the water to the water electrolyzer.

16. The method of claim 14, wherein the method does not require potassium hydroxide (KOH) or sulfuric acid (H₂SO₄).

17. The method of claim 14, wherein the second concentration of hydrogen peroxide in the water is at least 70%.

18. The method of claim 17, wherein the second concentration of hydrogen peroxide in the water is at least 90%.

19. An aerospace system comprising one or more controllers programmed with instructions that, when executed:
operate a proton-exchange membrane (PEM) cell to receive water and air, wherein the air comprises oxygen and the PEM cell combines hydrogen from the water and oxygen from the air to form a first hydrogen peroxide solution having a first concentration of hydrogen peroxide in water;
operate a hydrogen peroxide concentrator to remove at least some of the water from the first hydrogen peroxide solution to yield a second hydrogen peroxide solution that has a second concentration of hydrogen peroxide in water that is greater than the first concentration; and
operate a propulsion system of a space vehicle using the second hydrogen peroxide solution as propellant.

20. The aerospace system of claim 19, wherein the one or more controllers are further programmed with instructions that, when executed:
launch the space vehicle toward a first destination; and
land the space vehicle at the first destination; wherein:
operating the PEM cell comprises operating the PEM cell at the first destination; and
operating the hydrogen peroxide concentrator comprises operating the hydrogen peroxide concentrator at the first destination.

21. The aerospace system of claim 20, wherein the one or more controllers are further programmed with instructions that, when executed, operate a water harvesting system to produce or harvest water from the first destination.

22. The aerospace system of claim 20, wherein the one or more controllers are further programmed with instructions that, when executed, launch the space vehicle from the first destination, wherein launching the space vehicle from the first destination comprises operating the propulsion system of the space vehicle using the second hydrogen peroxide solution as propellant.

23. The aerospace system of claim 19, wherein the one or more controllers are further programmed with instructions that, when executed, operate a water electrolyzer to produce the air from water.

24. The aerospace system of claim 23, further comprising the space vehicle, the PEM cell, the hydrogen peroxide concentrator, and the water electrolyzer, and wherein the space vehicle carries the PEM cell, the hydrogen peroxide concentrator, and the water electrolyzer.
